(19) United States
(12) Patent Application Publication
(10) Pub. No.: US 2025/0103099 A1
(43) Pub. Date: Mar. 27, 2025

(54) Mechanical Magnetic Dock Release

(71) Applicant: Google LLC, Mountain View, CA (US)

(72) Inventors: Nicholas Sanders, Saratoga, CA (US); Jose Madrid, Mountain View, CA (US)

(73) Assignee: Google LLC, Mountain View, CA (US)

(21) Appl. No.: 18/898,045

(22) Filed: Sep. 26, 2024

Related U.S. Application Data
(60) Provisional application No. 63/585,480, filed on Sep. 26, 2023.

(51) Int. Cl. G06F 1/16; G01L 5/00

(52) U.S. Cl. CPC G06F 1/1632; G01L 5/0033; G06F 1/1626

(57) ABSTRACT

A tablet dock system includes a dock housing and a mating surface formed by the dock housing. A tablet computer is removably docked with the tablet dock system in contact with the mating surface. The system includes a force sensor disposed within the dock housing. The force sensor performs measurements indicative of in-progress undocking of the tablet computer from the dock. The system also includes a magnet component disposed within the dock housing. The magnet component includes one or more magnets, and the magnetic component retracts within the dock housing and away from the mating surface in response to the measurements indicative of undocking the tablet computer from the dock.

### CROSS-REFERENCE TO RELATED APPLICATION

This application claims the benefit of U.S. Provisional Patent Application No. 63/585,480, filed Sep. 26, 2023. The entire disclosure of the aforementioned Application is hereby incorporated by reference, for all purposes, as if fully set forth herein.

### BACKGROUND

Tablet computing devices, sometimes referred to as tablets or as tablet computers, are generally planar, lightweight devices that include a touch-screen display. Tablets are battery powered and can be plugged in or connected with a charging dock to recharge the tablet's battery.

### SUMMARY

According to one embodiment, a tablet dock system includes a dock housing and a mating surface formed by the dock housing. A tablet computer is removably docked with the tablet dock system in contact with the mating surface. The system includes a force sensor disposed within the dock housing. The force sensor performs measurements indicative of in-progress undocking of the tablet computer from the dock. The system also includes a magnet component disposed within the dock housing. The magnet component includes one or more magnets, and the magnetic component retracts within the dock housing and away from the mating surface in response to the measurements indicative of undocking the tablet computer from the dock.

The tablet dock system may include various optional embodiments. The system may include an actuator where the magnet component is retracted within the dock housing and away from the mating surface by the actuator within the dock housing and coupled to the magnet component. The actuator may be a linear actuator. The actuator may be a rotational actuator. The magnet component may be retracted within the dock housing and away from the mating surface between 1 mm and 2 mm. The magnet component may include at least two magnets. The system may include one or more processors that determine that the tablet computer is undocking from the dock based on one or more received measurements from the force sensor.

According to another embodiment, a tablet dock system includes a dock housing and a mating surface formed by the dock housing. A tablet computer is removably docked with the tablet dock system in contact with the mating surface. The system includes a force sensor disposed within the dock housing. The force sensor performs measurements indicative of in-progress undocking of the tablet computer from the dock. The system also includes a pushrod mechanism disposed within the dock housing. The pushrod mechanism advances within the dock housing and toward the mating surface in response to measurements indicative of undocking the tablet computer from the dock.

The tablet dock system may include various optional embodiments. The system may include an actuator where the pushrod mechanism is advanced within the dock housing and toward the mating surface by the actuator within the dock housing and coupled to the pushrod mechanism. The actuator may be a linear actuator. The actuator may be a rotational actuator. The pushrod mechanism may be advanced from within the dock housing and toward the mating surface. The pushrod mechanism may include at least two protrusions that extend through the mating surface when the pushrod mechanism is advanced toward the mating surface. The system may include one or more processors that determine that the tablet computer is undocking from the dock based on one or more received measurements from the force sensor.

According to yet another embodiment, a tablet dock system includes a dock having a dock housing and a tablet computer which can be removably docked from a mating surface of the dock, the tablet computer comprising an electronic display. The system may include one or more force sensors formed on the dock for detection of a force or pressure distribution associated with undocking of the tablet computer from the dock and a magnet component disposed within the dock housing. The magnet component includes one or more magnets, and the magnetic component retracts within the dock housing and away from the mating surface in response to measurements from the one or more force sensors indicative of undocking the tablet computer from the dock.

The tablet dock system may include various optional embodiments. The system may include an actuator where the magnet component is retracted within the dock housing and away from the mating surface by the actuator within the dock housing and coupled to the magnet component. The actuator may be a linear actuator. The actuator may be a rotational actuator. The magnet component may be retracted within the dock housing and away from the mating surface between 1 mm and 2 mm. The system may include one or more processors that determine that the tablet computer is undocking from the dock based on one or more received measurements from the one or more force sensors.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates a block diagram of a tablet computer dock system, according to an embodiment of the present disclosure.

FIGS. 2A and 2B illustrates a magnetic component disposed within a dock for decreasing the gripping force of an electronic device docked to the dock, according to an embodiment of the present disclosure.

FIGS. 3A-3C illustrates a pushing rod mechanism disposed within a dock for decreasing the gripping force of an electronic device docked to the dock, according to an embodiment of the present disclosure.

FIG. 4 is a flowchart of a method, according to an embodiment of the present disclosure.

### DETAILED DESCRIPTION

Electronic devices, such as a tablet computer, may be docked to supply power, for data transfer, for audio playback, and/or be physically held, such as in an upright position. A docking mechanism for docking electronic device can include arrangements of permanent magnets. For example, an electronic device and/or a dock may include a set of permanent magnets that magnetically couple with magnets in the dock and/or electronic device, respectively.

Magnetically docking a tablet computer to a dock uses a high holding force to withstand touch and/or button inputs without causing unintended undocking. However, a high holding force makes docking and undocking the tablet computer difficult as the tablet computer is very “sticky,” and a user must apply an opposing force to pry the tablet computer off of the dock. A high holding force may be a further issue if the dock is not stationary, e.g., with a hinged mount point.

In various embodiments described herein, to release a tablet computer from a magnetic dock easily and in a manner that optimizes the user experience, the magnetic gripping force is reduced between 60% and 80% from the optimal holding force. Accordingly, the tablet computer is relatively smooth to remove (e.g., undock) from the dock but the tablet computer does not drop off the dock unexpectedly, even if the user does not have a stable grip on the tablet computer. The magnetic gripping force or holding force is generally proportional to the distance between corresponding magnets (e.g., magnetically attracted magnets) and drops off quickly as the distance between the magnets increases. Mechanically separating corresponding magnets by a small, tuned amount enables a temporarily reduced gripping force for undocking the tablet computer from the dock.

According to at least some embodiments, an actuator within the dock either pulls magnets within the dock away from corresponding magnets within the tablet computer or pushes magnets within the tablet computer away from corresponding magnets within the dock.

The embodiments detailed herein are focused on a dock having an actuator within the dock housing that improves the undocking experience when undocking an electronic device from the dock. In some embodiments, the electronic device is a tablet computer that is a component of a tablet computer system. Specifically, a tablet computer can serve as a home assistant device and/or hub to manage smart home devices in an environment. The tablet computer may be able to charge and output audio via the dock, record video, communicate with a remote server system, and interact with users via spoken communications. For example, a home assistant device may provide automated control or voice control of devices, appliances, and systems, such as heating, ventilation, and air conditioning (“HVAC”) system, lighting systems, home theater, entertainment systems, as well as security systems. Smart home networks may include control panels that a person may use to input settings, preferences, and scheduling information that the smart home network uses to provide automated control of the various devices, appliances, and systems in the home. For example, the person may input a schedule indicating when the person is away from the home, and the smart home network uses this information along with information obtained from various devices in the home to detect unauthorized entry when the user is away. The tablet computer may be left docked with a dock to charge its battery and use other features of the dock, such as an integrated speaker. The tablet computer may be removed from the dock for convenience to be used or displayed at another location. When not in use (whether docked, not docked, or both), photos or photo albums selected by a user may be presented by the tablet.

Many other types of electronic devices may benefit from the various assisted undocking implementations described herein. For example, smartphones, gaming devices, e-readers, personal digital assistants (PDAs), digital paper tablets, and smart picture frames that can be removably attached with a base or another device may benefit from various embodiments of the assisted undocking mechanisms as detailed herein. Furthermore, the electronic device may be an assistant device (e.g., Google® Nest® Hub; Google® Nest® Hub Max); a home automation controller (e.g., controller for an alarm system, thermostat, lighting system, door lock, motorized doors, etc.); a gaming device (e.g., a gaming system, gaming controller, data glove, etc.); a communication device (e.g., a smart phone such as a Google® Pixel® Phone, cellular phone, mobile phone, wireless phone, portable phone, radio telephone, etc.); and/or other computing device (e.g., a tablet computer such as a Pixel® tablet, phablet computer, notebook computer, laptop computer, etc.).

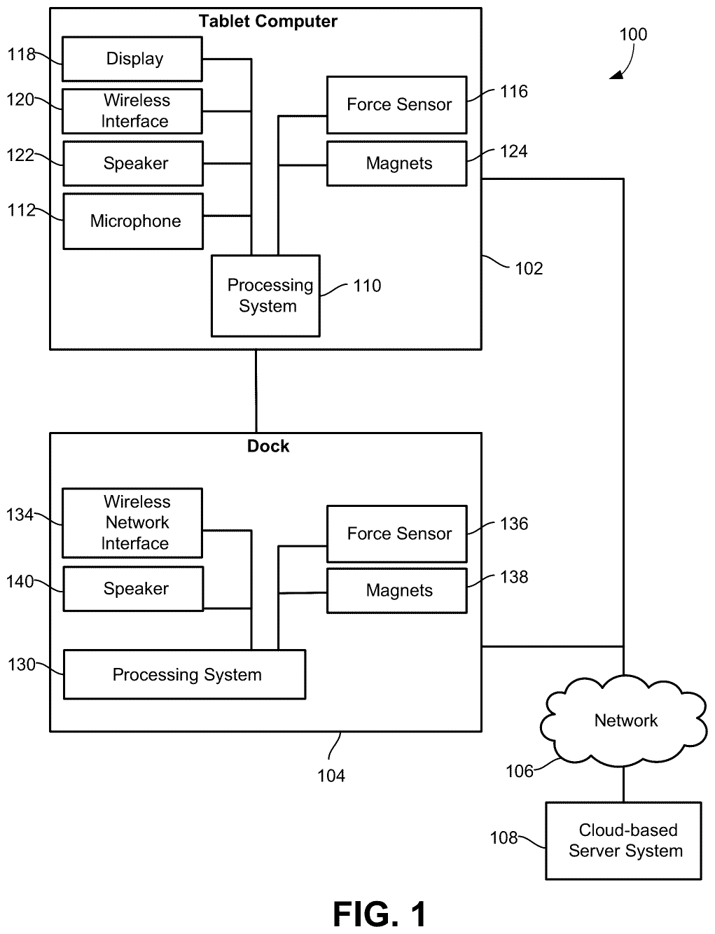

FIG. 1 illustrates an embodiment of a tablet dock system 100. Tablet dock system 100 can include tablet computer 102, a dock 104, a network 106; and cloud-based server system 108. The tablet computer 102 can include: processing system 110; one or more microphones 112; a force sensor 116; an electronic display 118; and a wireless interface 120. Processing system 110 may include one or more processors, which can include special-purpose or general-purpose processors that execute instructions stored using one or more non-transitory processor readable mediums. Processing system 110 can include one or more processors that are designed to execute machine learning (ML) models. Such processors, while able to analyze whether speech is or is not present, may not be able to analyze the content of such speech. Therefore, privacy of the content of the speech is maintained. Syntiant® Neural Decision Processors™ represent one family of commercial processors that can execute a machine learning model that is trained to determine the presence of speech but otherwise ignore the content of such speech.

Microphones 112 receive audio input from a user of the tablet computer 102. One or more microphones 112 may be in communication with processing system 110. If multiple microphones 112 are present, based upon the difference in time of arrival of sound at the multiple microphones, a direction from which a sound, such as speech, originated may be determined in relation to a SIM device. One or more microphones 112 may be in direct communication with only processing system 110 via a direct connection. Specifically, one or more microphones 112 can be electrically connected to only a processor that executes a machine learning model that determines (e.g., a binary determination of whether or not speech is determined to be present) or scores (e.g., indicates a likelihood of speech being present) if speech is or is not present. The processor does not have the capability to analyze the content of the speech. In various embodiments, the tablet computer 102 may include a speaker 122 of a type known in the art to output audio feedback to commands.

Force sensor 116 is in communication with processing system 110. One or more force

sensor 116 may include an IMU, an accelerometer, a gyroscope, a barometer, etc., or any combination thereof. Force sensors 116 are used to detect signals indicative of intent to undock and/or dock the tablet computer 102 from the dock 104. In some embodiments, force sensor 116 can be used to determine the orientation of the tablet computer 102 to the ground based on the acceleration of gravity and can be used to determine movement of the tablet computer 102. In other embodiments, the tablet computer 102 may comprise any force sensor described herein.

Magnets 124 may include one or more magnets arranged to magnetically couple with corresponding one or more magnets 138 of the dock 104. Magnets 124 and magnets 138 may be used to align the tablet computer 102 with the dock 104 during docking. Magnets 124 (or magnets 138) may include EPMs or permanent magnets, or a combination thereof.

Wireless interface 120 is in communication with processing system 110 and allows for communication with various wireless networks and/or wireless devices using one or more communication protocols. Wireless interface 120 may allow for communication with a Wi-Fi based wireless local area network. Wireless interface 120 can allow for communication directly with other devices, such as via Bluetooth, Bluetooth Low Energy (BLE), or some other low-power device-to-device communication protocol. In some embodiments, wireless interface 120 allows for communication with a wearer's smartphone, thus allowing information collected using the tablet computer 102 to be analyzed by and presented using the wearer's smartphone.

In some embodiments, electronic display 118 may be present. In various embodiments, the electronic display 118 may display any visual information associated with any applications running on the tablet computer 102 known in the art. Electronic display 118 can allow for information determined based on data collected from the various sensors of the tablet computer 102 to be directly presented to a user. For example, the electronic display 118 may display information or commands associated with smart home devices, social media applications, internet searches, weather applications, news applications, etc. For instance, electronic display 118 may be able to present text and/or graphical indications of whether the wearer's social interactions are above, at, or below a goal for a specific time period, such as a day.

The tablet computer 102 may be or may be used with a smartphone, a smartwatch, laptop, gaming device, or a smart home hub device that is used to interact with various smart home devices present within a home. The dock 104 may generally be part of a smart home assistant device system. Generally, the dock 104 can include a housing that houses all of the components of the dock 104.

The dock 104 can include a processing system 130. Processing system 130 can include one or more processors that perform various functions. Processing system 130 can include one or more special-purpose or general-purpose processors. Such special-purpose processors may include processors that are specifically designed to perform the functions detailed herein. Such special-purpose processors may be ASICs or FPGAs which are general-purpose components that physically and electrically perform the functions detailed herein. Such general-purpose processors may execute special-purpose software that is stored using one or more non-transitory processor-readable mediums, such as random access memory (RAM), flash memory, a hard disk drive (HDD), or a solid state drive (SSD).

Dock 104 may include a force sensor 136 such as the force sensor 116 located on the tablet computer 102 and described throughout the present disclosure. The dock 104 may include a speaker 140 (similar to speaker 122) of a type known in the art to output audio feedback to commands.

In various embodiments, other sensors, or components (not shown) may be located on the dock 104. For example, one or more environmental sensors may be incorporated into the dock 104 and can include a light sensor, a microphone for receiving audio input from a user, a temperature sensor, etc. In some embodiments, multiple instances of some or all of these sensors may be present. A camera and/or humidity sensor may be incorporated into the dock 104 and/or the tablet computer 102. As another example, active infrared sensors may be included. In some embodiments, some data, such as humidity data, may be obtained from a nearby weather station that has data available via the Internet. In some embodiments, active acoustic sensing methods, including, but not limited to, sonar and ultrasound, and including either single or arrayed acoustic sources and/or receivers may be implemented. Such arrangements may be used as one or more adjunct sensing modalities incorporated with the other sensors and methods described herein.

Tablet computer 102 may include various interfaces. Display 118, which may be a touchscreen, can allow processing system 110 to present information for viewing by one or more users. A wireless network interface can allow for communication using a wireless local area network (WLAN), such as a WiFi-based network. Speaker 122 can allow for sound, such as synthesized speech, to be output. For instance, responses to spoken commands received via microphone 112 may be output via speaker 122 and/or display 118. The spoken commands may be analyzed locally by the tablet computer 102 or may be transmitted via a wireless network interface to cloud-based server system 108 for analysis. A response, based on the analysis of the spoken command, can be sent back to the tablet computer via the wireless network interface for output via speaker 122 and/or display 118. Additionally, or alternatively, the speaker 122 and microphone 112 may collectively provide active acoustic sensing, including ultrasonic acoustic sensing. Additionally, or alternatively, other forms of wireless communication may be possible, such as using a low-power wireless mesh network radio and protocol (e.g., Thread) to communicate with various smart home devices. In some embodiments, a wired network interface, such as an Ethernet connection, may be used for communication with a network. Further, the evolution of wireless communication to fifth generation (5G) and sixth generation (6G) standards and technologies provides greater throughput with lower latency which enhances mobile broadband services. 5G and 6G technologies also provide new classes of services, over control and data channels, for vehicular networking (V2X), fixed wireless broadband, and the Internet of Things (IoT). Such standards and technologies may be used for communication by the tablet computer 102.

The low-power wireless mesh network radio and protocol may be used for communicating with power limited devices. A power-limited device may be an exclusively battery powered device. Such devices may rely exclusively on one or more batteries for power and therefore, the amount of power used for communications may be kept low in order to decrease the frequency at which the one or more batteries need to be replaced. In some embodiments, a power-limited device may have the ability to communicate via a relatively high-power network (e.g., WiFi) and the low-power mesh network. The power-limited device may infrequently use the relatively high-power network to conserve power. Examples of such power-limited devices include environmental sensors (e.g., temperature sensors, carbon monoxide sensors, smoke sensors, motion sensors, presence detectors) and other forms of remote sensors.

Notably, some embodiments of the tablet computer 102 do not have any still camera or video camera. By not incorporating an on-board camera, users nearby may be reassured about their privacy. For example, the tablet computer 102 can typically be installed in a user's bedroom. For many reasons, a user would not want a camera located in such a private space or aimed toward the user while the user is sleeping. In other embodiments, the tablet computer 102 may have a camera, but the camera's lens may be obscured by a mechanical lens shutter. In order to use the camera, the user may be required to physically open the shutter to allow the camera to have a view of the environment of the tablet computer 102. The user can be assured of privacy from the camera when the shutter is closed.

Wireless network interface 134 can allow for wireless communication with network 106. Network 106 can include one or more public and/or private networks. Network 106 can include a local wired or wireless network that is private, such as a home wireless LAN. Network 106 may also include a public network, such as the Internet. Network 106 can allow for the tablet computer 102 to communicate with remotely located cloud-based server system 108.

Cloud-based server system 108 may additionally or alternatively provide other cloud-based services. For instance, the tablet computer 102 may additionally function as a home assistant device. A home assistant device may respond to vocal queries from a user. In response to detecting a vocal trigger phrase being spoken, the tablet computer 102 may record audio. A stream of the audio may be transmitted to cloud-based server system 108 for analysis. Cloud-based server system 108 may perform a speech recognition process, use a natural language processing engine to understand the query from the user, and provide a response to be output by the tablet computer 102 as synthesized speech, an output to be presented on display 118, and/or a command to be executed by the tablet computer 102 (e.g., raise the volume of the tablet computer 102) or sent to some other smart home device. Further, queries or commands may be submitted to cloud-based server system 108 via display 118, which may be a touchscreen. For instance, the tablet computer 102 may be used to control various smart home devices or home automation devices. Such commands may be sent directly by the tablet computer 102 to the device to be controlled or may be sent via cloud-based server system 108.

Although various embodiments of an assisted undocking mechanism described herein are described with respect to a tablet dock system, the assisted undocking mechanism including an actuator that increases the distance between magnets may be implemented in a variety of applications. For example, the assisted undocking mechanism may be applied to magnetic docking to laptops, keyboards, phone docks, or the like.

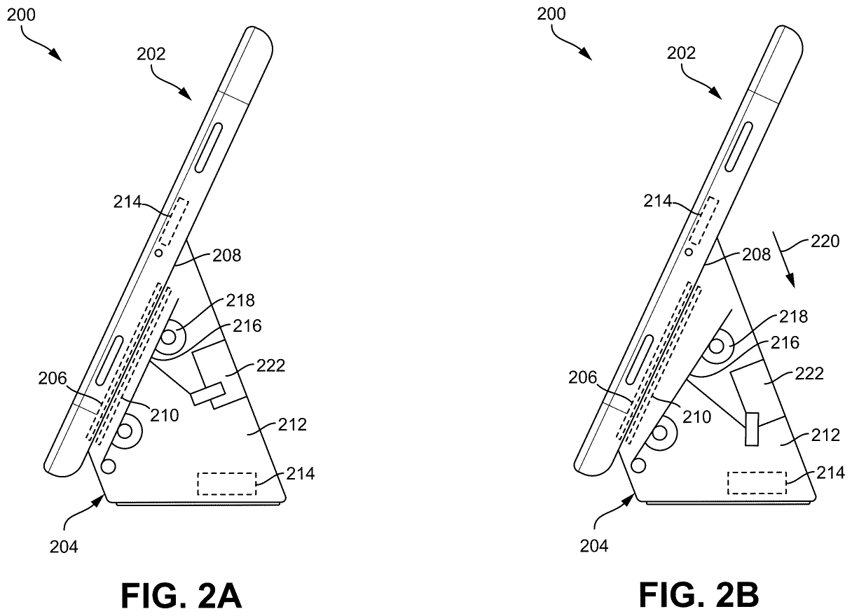

FIGS. 2A and 2B illustrates a magnetic component disposed within a dock for decreasing the gripping force of an electronic device docked to the dock, according to an embodiment of the present disclosure. FIGS. 2A and 2B illustrate a side view of a tablet dock system 200 that includes an embodiment of an electronic device 202 attached with a dock 204. As can be seen from the side view, the electronic device 202 is docked with dock 204. Electronic device mating surface 206 indicates where at least a portion of the rear surface 208 of the electronic device 202 contacts the dock 204.

Within the electronic device mating surface 206 (or a portion of the electronic device 202 proximate to the electronic device mating surface 206), a first plurality of magnets (not shown) is present within the electronic device 202. In a corresponding location within dock mating surface 210, a second plurality of magnets (not shown) is present within the dock 204. The magnets are arranged such that, when brought into proximity, the magnets of the electronic device 202 attract to the magnets of the dock 204 to help correctly position and align the dock 204 against the electronic device 202 and hold the electronic device 202 in a correct position on the dock 204. In other embodiments, electronic device mating surface 206 and dock mating surface 210 may extend further upward on the dock 204 and/or extend the length of the dock 204 which contacts the electronic device 202. For example, electronic device mating surface 206 and dock mating surface 210 may be any size and located at any location on the electronic device 202 and/or the dock 204.

The dock 204 of the tablet dock system 200 includes a dock housing 212. The dock housing forms the dock mating surface 210 where the electronic device 202 is removably docked with the dock 204. A force sensor 214 is disposed within the dock housing 212 and performs measurements indicative of in-progress undocking of the electronic device 202 from the dock 204. The force sensor 214 may be of any type known in the art or otherwise specified herein. Although the force sensor 214 is shown as disposed near a bottom surface of the dock housing 212, the force sensor 214 may be located at various locations within the dock housing 212 and any number of force sensors 214 may be disposed within the dock housing 212.

A force sensor 214 may be disposed within the electronic device 202. For example, a force sensor 214 may include an IMU, an accelerometer, a gyroscope, a barometer, etc., or any combination thereof. The force sensor 214 may be used to detect signals indicative of intent to undock and/or dock the electronic device 202 from the dock 204. In some embodiments, force sensor 214 can be used to determine the orientation of the electronic device 202 to the ground based on the acceleration of gravity and can be used to determine movement of the electronic device 202 (e.g., such as when the electronic device 202 is lifted up and away from the dock 204 during undocking).

A magnet component 216 is disposed within the dock housing 212. As shown in FIG. 2A, the magnet component 216 is in a disengaged position where the magnet component 216 is substantially aligned with the dock mating surface 210. For example, in the disengaged position, the magnetic component 216 is abutted against the interior of the dock housing 212 at or near the dock mating surface 210. In various embodiments, the magnet component 216 includes one or more magnets 218. For example, magnet component 216 may include at least two magnets 218. In some embodiments, the magnet component 216 includes all of or one or more of the second plurality of magnets of the dock 204 that magnetically couple to the first plurality of magnets within the electronic device 202 to hold the electronic device 202 in the docked position on the dock 204 (e.g., as shown in FIG. 2A).

As shown in FIG. 2B, the magnetic component 216 retracts within the dock housing 212 and away 220 from the dock mating surface 210 (and the electronic device mating surface 206) in response to the measurements indicative of undocking the electronic device 202 from the dock 204. The magnetic component 216 retracted within the dock housing 212 may be alternatively referred to as the engaged position of the tablet dock system 200. For example, the force sensors 214 perform and output measurements indicative of an intent to undock the electronic device 202 and one or more processors (not shown) actuate an actuator 222 disposed within the dock housing 212 and coupled to the magnet component 216. One or more processors may determine that the electronic device 202 is undocking from the dock 204 based on one or more received measurements from the force sensor 214. The magnet component 216 is retracted within the dock housing 212 and away 220 from the dock mating surface 210 (and the electronic device mating surface 206) by the actuator 222 within the dock housing 212 and coupled to the magnet component 216. The actuator 222 may be a servo arm, as would be appreciated by one having ordinary skill in the art upon reading the present disclosure. In some embodiments, the actuator 222 includes a spring load/release mechanism. For example, a spring may be compressed to place the electronic device 202 in the docked position (as shown in FIG. 2A), the spring release may power the undocking for quick actuation, and, after actuation, the spring may be reset. This reset may be a non-time critical reset between docking and undocking the electronic device 202. In various embodiments, the actuator 222 may be a hinged or four-bar linkage. In some embodiments, the actuator 222 is a linear actuator. In some embodiments, the actuator 222 is a rotational actuator.

According to at least some embodiments, the magnet component 216 is retracted within the dock housing 212 and away 220 from the dock mating surface 210 (and the electronic device mating surface 206) between 1 mm and 2 mm. In some embodiments, the magnetic component 216 is retracted away 200 from the dock mating surface 210 (and the electronic device mating surface 206) a distance that is sufficient to decrease the magnetic attraction between the first plurality of magnets of the electronic device 202 and the second plurality of magnets in the dock 204 (e.g., including magnets 218). All or part of the magnet component 216 may be retracted between 1 mm and 2 mm. For example, a top portion of the magnet component 216 may be pivotally retracted away 220 from the dock mating surface 210 (and the electronic device mating surface 206) a distance that is sufficient to decrease the magnetic attraction between the first plurality of magnets of the electronic device 202 and the second plurality of magnets in the dock 204 (e.g., including magnets 218).

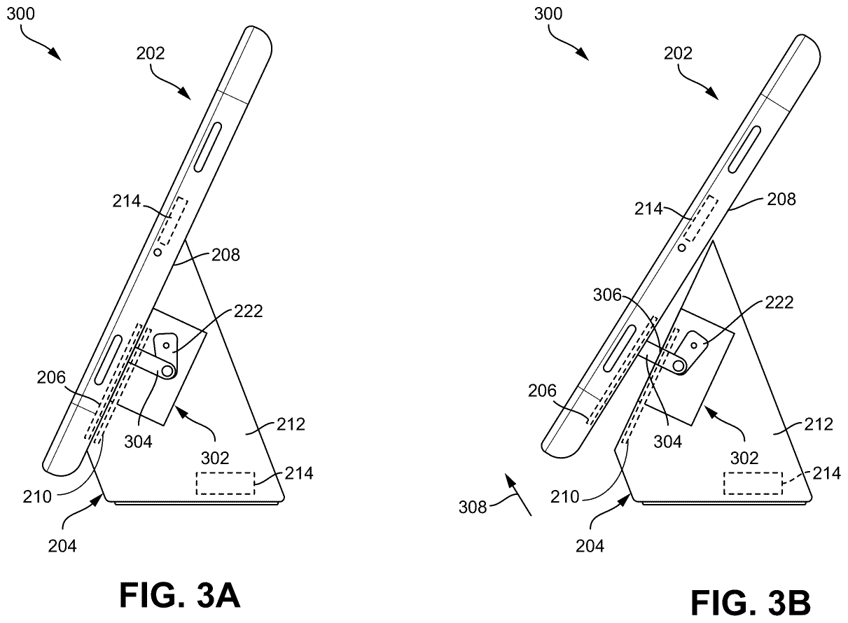

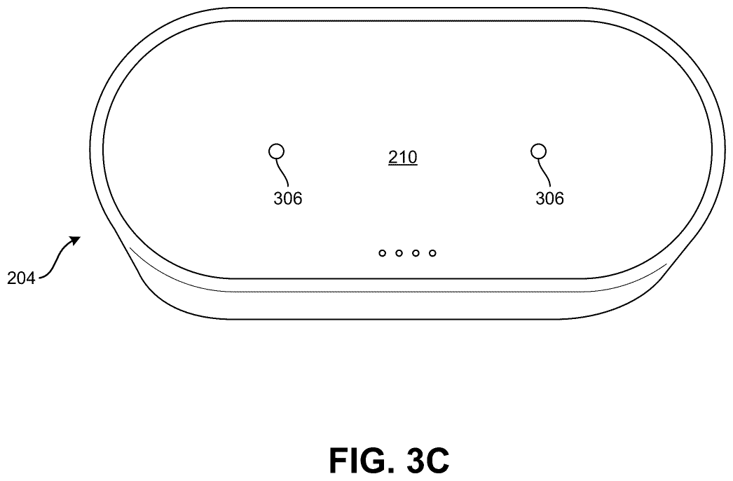

FIGS. 3A-3C illustrates a pushing rod mechanism disposed within a dock for decreasing the gripping force of an electronic device docked to the dock, according to an embodiment of the present disclosure. The description of the tablet dock system 200 of FIGS. 2A and 2B is applicable to the pushing rod mechanism disposed within a dock for decreasing the gripping force of an electronic device docked to the dock. FIGS. 3A-3C illustrate a side view of a tablet dock system 300 that includes an embodiment of an electronic device 202 attached with a dock 204. As can be seen from the side view, the electronic device 202 is docked with dock 204. Electronic device mating surface 206 indicates where the rear surface 208 of the electronic device 202 contacts the dock 204.

Within the electronic device mating surface 206 (or a portion of the electronic device 202 proximate to the electronic device mating surface 206), a first plurality of magnets (not shown) is present within the electronic device 202. In a corresponding location within dock mating surface 210, a second plurality of magnets (not shown) is present within the dock 204. The magnets are arranged such that, when brought into proximity, the magnets of the electronic device 202 attract to the magnets of the dock 204 to help correctly position and align the dock 204 against the electronic device 202 and hold the electronic device 202 in a correct position on the dock 204. In other embodiments, electronic device mating surface 206 and dock mating surface 210 may extend further upward on the dock 204 and/or extend the length of the dock 204 which contacts the electronic device 202. For example, electronic device mating surface 206 and dock mating surface 210 may be any size and located at any location on the electronic device 202 and/or the dock 204.

The dock 204 of the tablet dock system 200 includes a dock housing 212. The dock housing forms the dock mating surface 210 where the electronic device 202 is removably docked with the dock 204. A force sensor 214 is disposed within the dock housing 212 and performs measurements indicative of in-progress undocking of the electronic device 202 from the dock 204. The force sensor 214 may be of any type known in the art or otherwise specified herein. Although the force sensor 214 is shown as disposed near a bottom surface of the dock housing 212, the force sensor 214 may be located at various locations within the dock housing 212 and any number of force sensors 214 may be disposed within the dock housing 212. A force sensor 214 may be disposed within the electronic device 202. For example, a force sensor 214 may include an IMU, an accelerometer, a gyroscope, a barometer, etc., or any combination thereof. The force sensor 214 may be used to detect signals indicative of intent to undock and/or dock the electronic device 202 from the dock 204. In some embodiments, force sensor 214 can be used to determine the orientation of the electronic device 202 to the ground based on the acceleration of gravity and can be used to determine movement of the electronic device 202 (e.g., such as when the electronic device 202 is lifted up and away from the dock 204 during undocking).

A pushrod mechanism 302 is disposed within the dock housing 212. As shown in FIG. 3A, the pushrod mechanism 302 is in a disengaged position where the pushrod mechanism 302 is substantially aligned with the dock mating surface 210. For example, in the disengaged position, the pushrod mechanism 302 is abutted against the interior of the dock housing 212 at or near the dock mating surface 210. In various embodiments, the pushrod mechanism 302 includes one or more protrusions 304 that extend through the dock mating surface 210 (e.g., through corresponding apertures 306) when the pushrod mechanism 302 is advanced toward 308 the dock mating surface 210 (and the electronic device mating surface 206). The pushrod mechanism 302 may include at least two protrusions 304.

As shown in FIG. 3B, the pushrod mechanism 302 advances within the dock housing 212 and toward 308 the dock mating surface 210 (and the electronic device mating surface 206) in response to measurements indicative of undocking the electronic device 202 from the dock 204. For example, the force sensors 214 perform and output measurements indicative of an intent to undock the electronic device 202 and one or more processors (not shown) actuate an actuator 222 disposed within the dock housing 212 and coupled to the magnet component 216. The one or more processors may determine that the electronic device 202 is undocking from the dock 204 based on one or more received measurements from the force sensor 214. The pushrod mechanism 302 is advanced within the dock housing 212 and toward 308 the dock mating surface 210 (and the electronic device mating surface 206) by an actuator 222 within the dock housing 212 and coupled to the pushrod mechanism 302. The actuator 222 may be a servo arm, as would be appreciated by one having ordinary skill in the art upon reading the present disclosure. In some embodiments, the actuator 222 includes a spring load/release mechanism. In some embodiments, the actuator 222 is a linear actuator. In some embodiments, the actuator 222 is a rotational actuator.

According to at least some embodiments, the one or more protrusions 304 are advanced out of the dock mating surface 210 between 1 mm and 2 mm. In some embodiments, the one or more protrusions 304 are advanced out of the dock mating surface 210 a distance that is sufficient to decrease the magnetic attraction between the first plurality of magnets of the electronic device 202 and the second plurality of magnets in the dock 204. As shown in FIG. 3C, the dock 204 includes a dock mating surface 210 including apertures 306 from which the protrusions 304 (not shown) of the pushrod mechanism 302 (not shown) extend when advanced by an actuator 222 (not shown), as described in detail above.

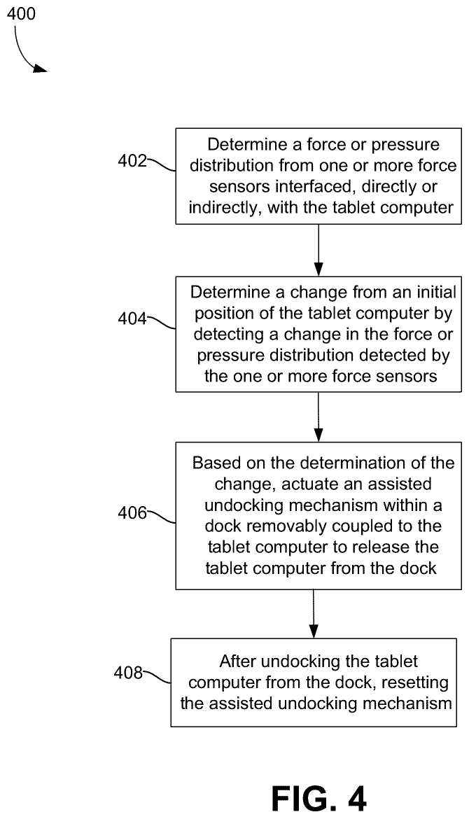

FIG. 4 includes a flowchart of a method 400 of undocking of a tablet computer from a dock. The description of tablet dock systems 100, 200, and 300 is applicable to the method of undocking of a tablet computer from a dock described herein. Step 402 of method 400 includes determining a force or pressure distribution from one or more force sensors interfaced, directly or indirectly, with the tablet computer. The one or more force sensors detects signals indicative of an initial position of the tablet computer relative to a dock. For example, the signals may be indicative that the tablet computer is docked or undocked. The one or more force sensors may be any type of force sensor described in detail above. For example, the one or more force sensors may include a strain gauge, an inertial measurement unit (IMU) sensor, a barometer, etc., or any combination thereof. The force sensors may be integrated into the dock such that the force sensors interface, directly or indirectly, with the tablet computer. In various embodiments, the one or more force sensors may be located on, located within, integrated into, etc., in the dock. In at least some embodiments, at least one of the one or more force sensors is located in the tablet computer itself.

Step 404 includes determining a change from an initial position of the tablet computer by detecting a change in the force or pressure distribution detected by the one or more force sensors. For example, the one or more sensors detect signals indicative that the initial position of the tablet computer is docked. A processor in the tablet computer and dock system determines that the initial position is docked where the one or more force sensors detect a weight, a pressure, a force, etc., on the force sensors associated with the tablet computer's weight resting on the dock, in one embodiment. A change in the initial position may be determined by a change in the force or pressure distribution detected by the one or more sensors, for example, when the tablet computer is lifted off of the dock and stops applying pressure to the dock.

In at least some embodiments, a change in position is determined by the change in force or pressure distribution exceeding a predefined threshold. For example, detecting the change in force or pressure distribution comprises comparing a measured force with a stored predefined force value. A predefined threshold may be a hardcoded threshold determined and set by a manufacturer, a supplier, a user, etc. In other embodiments, the predefined threshold is generated by a machine learning model. For example, docking and undocking sensor data may be collected from a plurality of users. Machine learning models known in the art may be used to determine whether a change in force or pressure distribution is indicative of a change in position and differentiate the change from changes which result from other interactions with the tablet computer or dock. In various embodiments, the predefined threshold includes a time constraint. For example, if the force associated with the weight of the tablet computer on the dock is below a threshold for a given time (e.g., 50 to 100 ms), a change in position is determined by the system comprising the tablet computer and the dock.

Step 406 includes, based on determination, actuating an assisted undocking mechanism within a dock removably coupled to the tablet computer to release the tablet computer from the dock. For example, an actuator (such as actuator 222 described in detail above) may be actuated to either retract a magnetic component within the dock housing or advance protrusions of a pushrod mechanism out of the dock mating surface to increase the distance between magnets within the tablet computer and magnets within the dock that enable docking of the tablet computer to the dock. As described above, the magnetic force between magnetically attracted magnets generally decreases as the amount of separation between the magnets increases (not proportionally). Accordingly, the assisted undocking mechanism including the magnet component or the pushrod mechanism described herein may be used to temporarily, and in a tuned manner, decrease the magnetic holding force that keeps the tablet computer docked to the dock, thereby improving the undocking experience for a user.

Step 408 includes after undocking the tablet computer from the dock, resetting the assisted undocking mechanism. For example, the actuator may retract the protrusions of the pushrod mechanism from apertures in the dock mating surface or the actuator may return the magnet component to the disengaged position (as shown in FIG. 2A) where the magnet component abuts the dock mating surface such that magnets on the magnet component may magnetically couple with magnets of the tablet computer when the tablet computer is docked to the dock.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known, processes, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A tablet dock system comprising:
a dock housing;
a mating surface formed by the dock housing, wherein a tablet computer is removably docked with the tablet dock system in contact with the mating surface;
a force sensor disposed within the dock housing, wherein the force sensor performs measurements indicative of in-progress undocking of the tablet computer from the dock; and
a magnet component disposed within the dock housing, wherein:
the magnet component includes one or more magnets; and
the magnetic component retracts within the dock housing and away from the mating surface in response to the measurements indicative of undocking the tablet computer from the dock.

2. The system of claim 1, further comprising an actuator, wherein the magnet component is retracted within the dock housing and away from the mating surface by the actuator within the dock housing and coupled to the magnet component.

3. The system of claim 2, wherein the actuator is a linear actuator.

4. The system of claim 2, wherein the actuator is a rotational actuator.

5. The system of claim 1, wherein the magnet component is retracted within the dock housing and away from the mating surface between 1 mm and 2 mm.

6. The system of claim 1, wherein the magnet component includes at least two magnets.

7. The system of claim 1, further comprising one or more processors that determine that the tablet computer is undocking from the dock based on one or more received measurements from the force sensor.

8. A tablet dock system comprising:
a dock housing;
a mating surface formed by the dock housing, wherein a tablet computer is removably docked with the tablet dock system in contact with the mating surface;
a force sensor disposed within the dock housing, wherein the force sensor performs measurements indicative of in-progress undocking of the tablet computer from the dock; and
a pushrod mechanism disposed within the dock housing, wherein the pushrod mechanism advances within the dock housing and toward the mating surface in response to measurements indicative of undocking the tablet computer from the dock.

9. The system of claim 8, further comprising an actuator, wherein the pushrod mechanism is advanced within the dock housing and toward the mating surface by the actuator within the dock housing and coupled to the pushrod mechanism.

10. The system of claim 9, wherein the actuator is a linear actuator.

11. The system of claim 9, wherein the actuator is a rotational actuator.

12. The system of claim 8, wherein the pushrod mechanism is advanced from within the dock housing and toward the mating surface.

13. The system of claim 12, wherein the pushrod mechanism includes at least two protrusions that extend through the mating surface when the pushrod mechanism is advanced toward the mating surface.

14. The system of claim 8, further comprising one or more processors that determine that the tablet computer is undocking from the dock based on one or more received measurements from the force sensor.

15. A tablet computer system comprising:
a dock having a dock housing;
a tablet computer which can be removably docked from a mating surface of the dock, the tablet computer comprising an electronic display;
one or more force sensors formed on the dock for detection of a force or pressure distribution associated with undocking of the tablet computer from the dock; and
a magnet component disposed within the dock housing, wherein:
the magnet component includes one or more magnets; and
the magnetic component retracts within the dock housing and away from the mating surface in response to measurements from the one or more force sensors indicative of undocking the tablet computer from the dock.

16. The system of claim 15, further comprising an actuator, wherein the magnet component is retracted within the dock housing and away from the mating surface by the actuator within the dock housing and coupled to the magnet component.

17. The system of claim 16, wherein the actuator is a linear actuator.

18. The system of claim 16, wherein the actuator is a rotational actuator.

19. The system of claim 16, wherein the magnet component is retracted within the dock housing and away from the mating surface between 1 mm and 2 mm.

20. The system of claim 16, further comprising one or more processors that determine that the tablet computer is undocking from the dock based on one or more received measurements from the one or more force sensors.
